(19) United States
(12) Patent Application Publication
(10) Pub. No.: US 2006/0133529 A1
(43) Pub. Date: Jun. 22, 2006

(54) Apparatus and method for performing time domain channel estimation in a communication system

(75) Inventors: Seo-Goo Lee, Anyang-si (KR); Min-Cheol Park, Suwon-si (KR); Yun-Sang Park, Suwon-si (KR); Bong-Gee Song, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/313,897

(22) Filed: Dec. 21, 2005

(30) Foreign Application Priority Data
Dec. 21, 2004 (KR) 10-2004-0109955

(51) Int. Cl. H04K 1/10

(52) U.S. Cl. 375/260

(57) ABSTRACT

In an orthogonal frequency division multiplexing (OFDM) system, channel estimates of pilot subcarriers in a current input symbol are input, and time domain channel estimation for data subcarriers positioned between adjacent pilot subcarriers is performed by linear interpolating channel estimates of the adjacent pilot subcarriers associated with each of the pilot subcarriers in the current input symbol during a time interval of the current input symbol.

### PRIORITY

This application claims priority to an application filed in the Korean Intellectual Property Office on Dec. 21, 2004 and assigned Serial No. 2004-109955, the entire contents of which are incorporated herein by reference.

### BACKGROUND OF THE INVENTION

1. Field of the Invention

The present invention relates to apparatus and a method for performing time domain channel estimation.

2. Description of the Related Art

Orthogonal frequency division multiplexing (OFDM) scheme is a scheme for sending data in parallel using a plurality of subcarriers orthogonal to each other rather than a single carrier with a broad band. A communication system using the OFDM scheme (OFDM system) has a higher frequency efficiency and transmission rate than a communication system using a single carrier. The receiving side of the OFDM system needs to compensate for channel distortion of OFDM symbols (hereinafter, referred to as “symbol”) due to channel environments by estimating characteristics of the transmission channel, and compensates for symbol channel distortion.

More specifically, when the OFDM system is used to provide wireless Internet service, and the radio channel is time-varying. In this case, the channel estimation system is designed to continuously track the time-varying channel. To estimate the time-varying channel, the transmitting side sends pilot signals known by the receiving side through pilot subcarriers that are assigned to some subcarriers in a symbol. Then, the receiving side performs channel estimation for a subcarrier by which data is actually transmitted, through interpolation using the pilot signals.

Various techniques are used to assign a pilot in OFDM. Conventionally, the OFDM system periodically assigns and arranges a pilot within one symbol such that it is robust to frequency selectivity of a radio channel. The OFDM symbol structure is capable of estimating characteristics of a time-varying radio channel by periodically assigning a pilot in the time domain. An example of the symbol structure is illustrated in FIG. 1.

In the symbol structure of FIG. 1, pilots are assigned every for predetermined number of symbols with respect to defined subcarriers. The position of a pilot subcarrier between the subcarriers is shifted by a predetermined number of symbols, and a plurality of data subcarriers are positioned between adjacent pilot subcarriers on the time axis. FIG. 1 illustrates an example in which pilot subcarriers are assigned every three symbols on the time axis with respect to defined subcarriers, that is, subcarriers to which pilots are assigned every three subcarriers on the frequency axis, a position of a pilot subcarrier between the subcarriers is shifted in a unit of one symbol, and two data subcarriers are positioned between adjacent pilot subcarriers on the time axis. In FIG. 1, “●” denotes a pilot subcarrier used for transmitting a pilot, and “∘” denotes a data subcarrier used for transmitting data.

When a pilot is assigned as illustrated in FIG. 1, channel estimation for a data subcarrier, which transmits actual data as opposed to a pilot, is achieved by performing interpolation using pilot subcarriers adjacent to the data subcarrier.

Before the channel estimation for a data subcarrier, channel estimation for the pilot subcarrier is done first. Conventionally, the channel estimation for a pilot subcarrier uses a least square (LS) technique or a linear minimum mean square estimation (LMMSE) technique. The LS technique performs channel estimation by dividing a signal of a received pilot subcarrier as a known signal at the receiving side. The LMMSE technique is a channel estimation technique which takes an additive white Gaussian noise (AWGN) component in a radio link into consideration. The LS technique has a relatively simple hardware structure, but its performance level is lower than the LMMSE channel estimation technique. The LMMSE technique performs excellently, but its hardware is very complex.

As described above, channel estimation for a data subcarrier is based mainly on interpolation using adjacent pilot subcarriers. The interpolation technique may be an interpolation filter-based technique, a polynomial interpolation technique, a Wiener filter-based MMSE technique, or etc. The polynomial interpolation technique is most common. First-order linear interpolation in the polynomial interpolation technique is advantageous for its simple hardware design.

In channel estimation for data subcarriers, interpolation is performed in both the time and frequency domains. The channel estimation for all subcarriers is achieved by first performing the time domain interpolation and subsequently performing the frequency domain interpolation. According to the time domain interpolation, channel values serving as channel transfer functions of data subcarriers between adjacent pilot subcarriers on the time axis, that is, the symbol axis, within one symbol duration are estimated. In this case, performance degradation due to characteristics of a time-varying radio channel can be minimized by time domain interpolation. Then, performance degradation due to frequency selectivity of a radio channel can be minimized by the frequency domain interpolation.

FIG. 2 is a block diagram illustrating a channel estimator for performing channel estimation in an OFDM system. The channel estimator includes a pilot channel estimator 100, a time domain interpolator 102, and a frequency domain interpolator 104. The pilot channel estimator 100 receives, from a fast Fourier transform (FFT) processor (not shown), FFT data.

The pilot channel estimator 100 performs channel estimation for pilot subcarriers using, for example, the above-mentioned LS technique. The pilot subcarrier channel estimation values are applied to the time domain interpolator 102.

Using the channel estimate values of the pilot subcarriers, the time domain interpolator 102 performs time domain interpolation for data subcarriers in one symbol, to generate channel estimation values for the data subcarriers. The time domain interpolator 102 outputs the generated channel estimation values of the data subcarriers to the frequency domain interpolator 104. The time domain interpolator 102 outputs, to the frequency domain interpolator 104, the channel estimation values of the pilot subcarriers input from the pilot channel estimator 100.

The frequency domain interpolator 104 receives the channel estimation values of the pilot and data subcarriers in one symbol input from the time domain interpolator 102, and performs frequency domain interpolation. When the frequency domain interpolator 104 completes channel estimation, the channel estimation values of the data subcarriers in one symbol are applied to an equalizer, and used to compensate for channel distortion of a corresponding symbol.

The time domain channel estimation in the time domain interpolator 102 will be described in detail with reference to FIG. 3, which illustrates subcarriers with pilots assigned every three symbols on the time axis. Because data subcarriers with no assigned pilot are directly associated with the frequency domain interpolation rather than the time domain interpolation, they are omitted from FIG. 3. In FIG. 3, N, N−1, N−2, N−3, and N−4 each indicate one symbol. FIG. 3 illustrates an example where symbols are input in order of N−4→N−3→N−2→N−1→N. In FIG. 3, k, k+1, k+2, k+3, k+4, and k+5 denote subcarrier indices that respectively indicate one subcarrier to which pilots are assigned every three symbols from FIG. 1.

When an index of a symbol input into the channel estimator is N, the channel estimation is performed for the symbol of Index N−2 as illustrated in FIG. 3. That is, the (N−2)-th symbol is a current estimation target symbol. The time domain channel estimation for subcarriers in order of k→k+1−k+2−k+3×k+4−k+5→ . . . in the (N−2)-th symbol is performed such that the frequency domain interpolator 104 performs the frequency domain channel estimation associated with the (N−2)-th symbol.

The time domain channel estimation for the k-th data subcarrier among subcarriers in the (N−2)-th symbol serving as the current estimation target symbol is performed by linearly interpolating channel estimation values of the k-th pilot subcarriers in the (N−4)-th and (N−1)-th symbols adjacent to the k-th data subcarrier in the (N−2)-th symbol. The time domain channel estimation for the (k+1)-th data subcarrier in the (N−2)-th symbol is performed by linearly interpolating channel estimation values of the (k+1)-th pilot subcarriers in the (N−3)-th and N-th symbols adjacent to the (k+1)-th data subcarrier in the (N−2)-th symbol. Because the (k+2)-th pilot subcarrier in the (N−2)-th symbol is a pilot subcarrier from which the channel estimate has already been computed, its time domain channel estimation is not necessary, and the channel estimation value of the (k+2)-th pilot subcarrier is output to the frequency domain interpolator 104 as is.

The channel estimation for the remaining (k+3)-th, (k+4)-th, and (k+5)-th subcarriers in the (N−2)-th symbol, etc. is performed in the same way as that for the k-th, (k+1)-th, and (k+2)-th subcarriers in the (N−2)-th symbol. In the linear interpolation for the above-mentioned time domain channel estimation, channel estimation values for the pilot subcarriers in five consecutive symbols of N−4 to N including the current estimation target symbol, are used during the process. To do so, the time domain interpolator 102 stores the signal values of the subcarriers in the five symbols in memory.

For example, assuming that the number of subcarriers in the OFDM system is 1,024, and a signal value of each subcarrier input into the channel estimator is 12-bit data in each of the in-phase (I) and Quadrature (Q) channels, the number of memory bits needed to perform the channel estimation associated with one symbol is 1,024 (subcarriers)×12 (bits)×2 (channels)×5 (symbols)=122,880 (bits). When three or more data subcarriers are positioned between adjacent pilot subcarriers along the time axis, additional memory for the data subcarrier is required.

Because the above-mentioned frequency domain interpolation in the OFDM system can be completely performed in one symbol regardless of adjacent symbols, it does not require large-scale memory. However, because time domain interpolation uses a plurality of symbols, it requires a large-scale memory. When hardware size is taken into account, the memory required to perform time domain interpolation has to be reduced to perform channel estimation efficiently.

### SUMMARY OF THE INVENTION

Therefore, it is an aspect of the present invention to provide an apparatus and method for performing time domain channel estimation in a communication system.

It is another aspect of the present invention to provide an apparatus and method for performing time domain channel estimation to reduce the memory required for performing time domain channel estimation in a communication system.

The above and other aspects of the present invention can be accomplished by inputting channel estimates of pilot subcarriers in a current input symbol, and linearly interpolating channel estimates of adjacent pilot subcarriers associated with each of the pilot subcarriers in the current input symbol during a time interval of the current input symbol to perform time domain channel estimation for data subcarriers positioned between the adjacent pilot subcarriers.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates an example of assigning an orthogonal frequency division multiplexing (OFDM) pilot subcarrier;

FIG. 2 is a block diagram illustrating a conventional OFDM channel estimator;

FIG. 3 illustrates an example of conventional linear interpolation in the time domain;

FIG. 4 is a block diagram illustrating a time domain channel estimator in accordance with an embodiment of the present invention;

FIG. 5 illustrates details of an interpolator in accordance with an embodiment of the present invention;

FIGS. 6A and 6B illustrate examples of linear interpolation in the time domain in accordance with an embodiment of the present invention;

FIG. 7 is a flow chart illustrating a time domain channel estimation procedure in accordance with an embodiment of the present invention;

FIGS. 8A and 8B illustrate examples of time domain linear interpolation in accordance with an alternative embodiment of the present invention; and

FIG. 9 is a flow chart illustrating a time domain channel estimation procedure in accordance with a further alternative embodiment of the present invention.

### DETAILED DESCRIPTION OF THE PREFERRED EMBODIMENTS

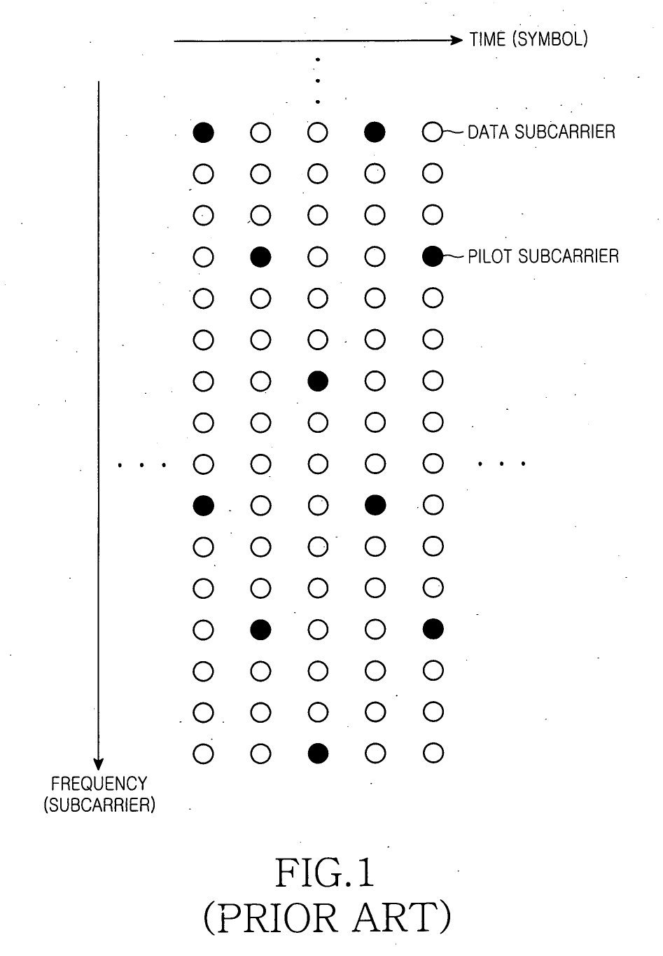

Preferred embodiments of the present invention will be described in detail herein below with reference to the accompanying drawings. In the following description, a detailed description of known functions and configurations incorporated herein will be omitted for conciseness. An example in which the present invention is applied to an orthogonal frequency division multiplexing (OFDM) system with the symbol structure of FIG. 1 will be described.

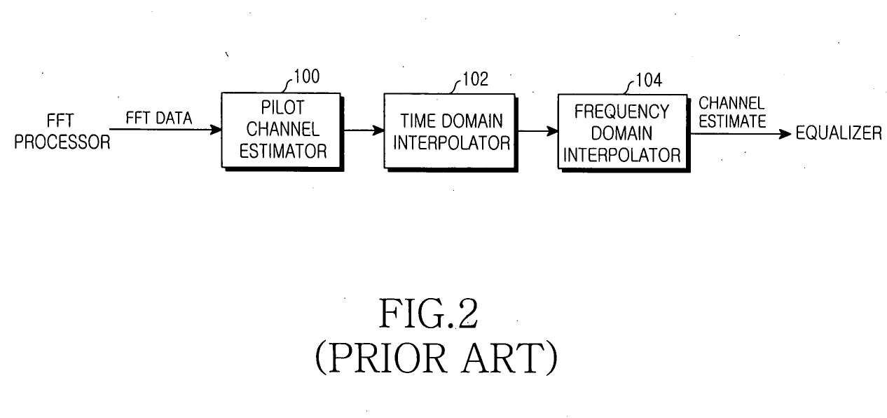

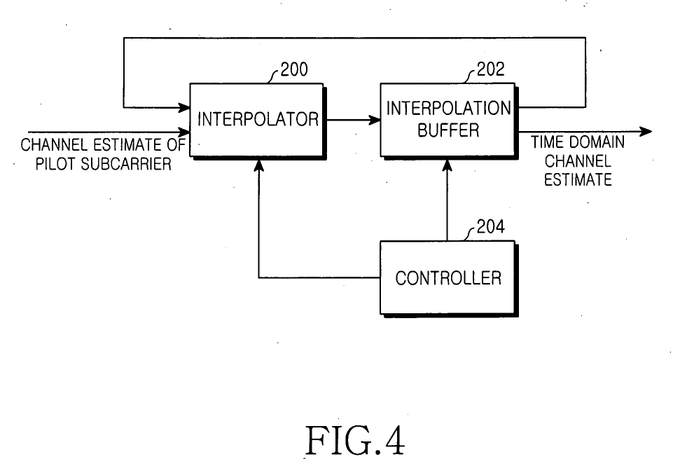

FIG. 4 is a block diagram of a time domain channel estimator in accordance with an embodiment of the present invention. The time domain channel estimator includes an interpolator 200, an interpolation buffer 202, and a controller 204. The time domain channel estimator of FIG. 4 corresponds to the time domain interpolator 102 of FIG. 2.

The interpolator 200 receives a channel estimation value of a current pilot subcarrier from the pilot channel estimator 100 of FIG. 2, and also receives a channel estimation value of a previous pilot subcarrier from the interpolation buffer 202. The term “current pilot subcarrier” refers to the pilot subcarrier associated with a current input channel estimate in a current input symbol. The term “previous pilot subcarrier” refers to the previous pilot subcarrier adjacent the current pilot subcarrier on the time axis. The interpolator 200 linearly interpolates the channel estimates of the current and previous pilot subcarriers. Then, the interpolator 200 generates channel estimation values of data subcarriers in the current and next estimation target symbols between the current and previous pilot subcarriers.

The interpolation buffer 202 preferably stores channel estimation values of pilot subcarriers in the current input symbol, channel estimation values of previous pilot subcarriers in the previous estimation symbol, channel estimation values of pilot subcarriers in the current estimation target symbol, and channel estimation values of data subcarriers in the next estimation target symbol.

The controller 204 controls linear interpolation in the interpolator 200, and controls storing and output operations in the interpolation buffer 202. The control is designed so that the time domain channel estimation for data subcarriers between the current and the previous pilot subcarriers is done during the current input symbol time interval.

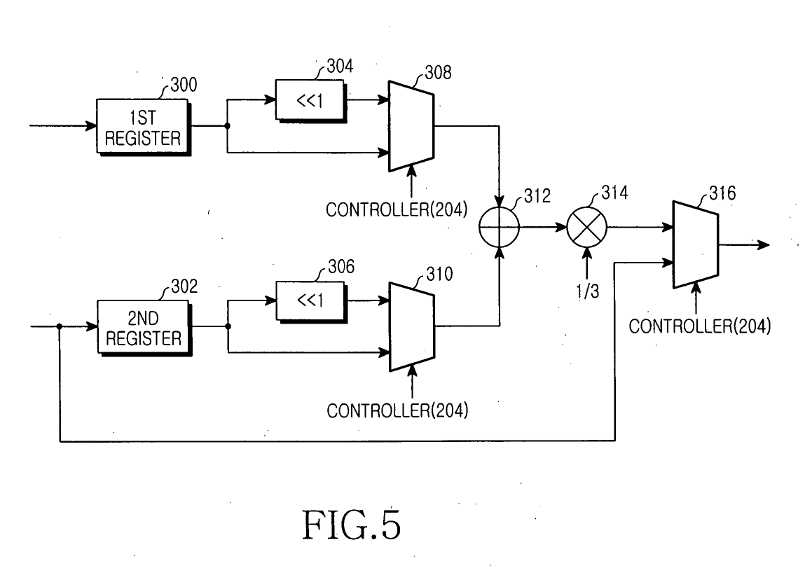

FIG. 5 illustrates details of the interpolator 200. A first register 300 receives and temporarily stores a channel estimation value of a previous pilot subcarrier from the interpolation buffer 202. A second register 302 receives and temporarily stores a channel estimation value of a current pilot subcarrier from the pilot channel estimator 100.

The channel estimation value of the previous pilot subcarrier temporarily stored in the first register 300 is doubled when a 1-bit shifter 304 shifts the channel estimation value by one to the more significant bit side. The original and doubled channel estimation value are input to the data selector 308. The data selector 308 selects either the output of the 1-bit shifter 304 (doubled channel estimation value) or the first register 300 (original channel estimation value) according to a control operation of the controller 204.

The channel estimation value of the current pilot subcarrier temporarily, is also doubled by a 1-bit shifter 306 in the same way. The original and doubled channel estimation value are input to the data selector 310. The data selector 310 selects either the output of the 1-bit shifter 306 or the second register 302 according to a control operation of the controller 204.

An adder 312 adds the outputs of the data selectors 308 and 310, and a multiplier 314 multiplies the sum by ⅓. The resulting product is then applied to a data selector 316. The data selector 316 selects either the resulting product from the multiplier 314 or the channel estimation value of the current pilot subcarrier stored in the second register 302 at the direction of the controller 204, and then sends the result to the interpolation buffer 202.

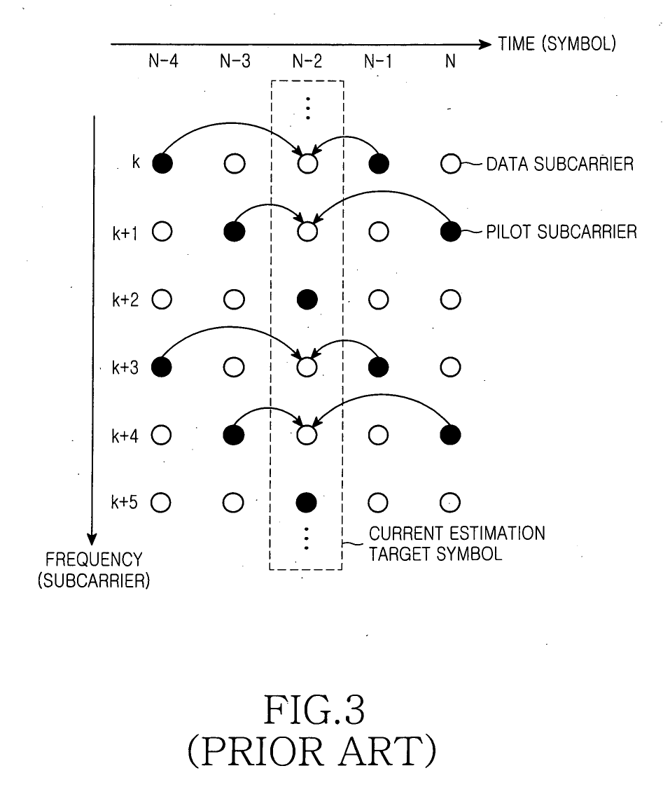

The time domain channel estimator of FIG. 4 performs time domain channel estimation for the data subcarriers between adjacent pilot subcarriers during a time interval of the current input symbol when performing channel estimation with linear interpolation. That is, in case of the symbol structure of FIG. 1, the time domain channel estimation is performed during the time interval of two symbols as illustrated in FIG. 3. However, in accordance with an embodiment of the present invention, time domain channel estimation is performed during the time interval of one symbol.

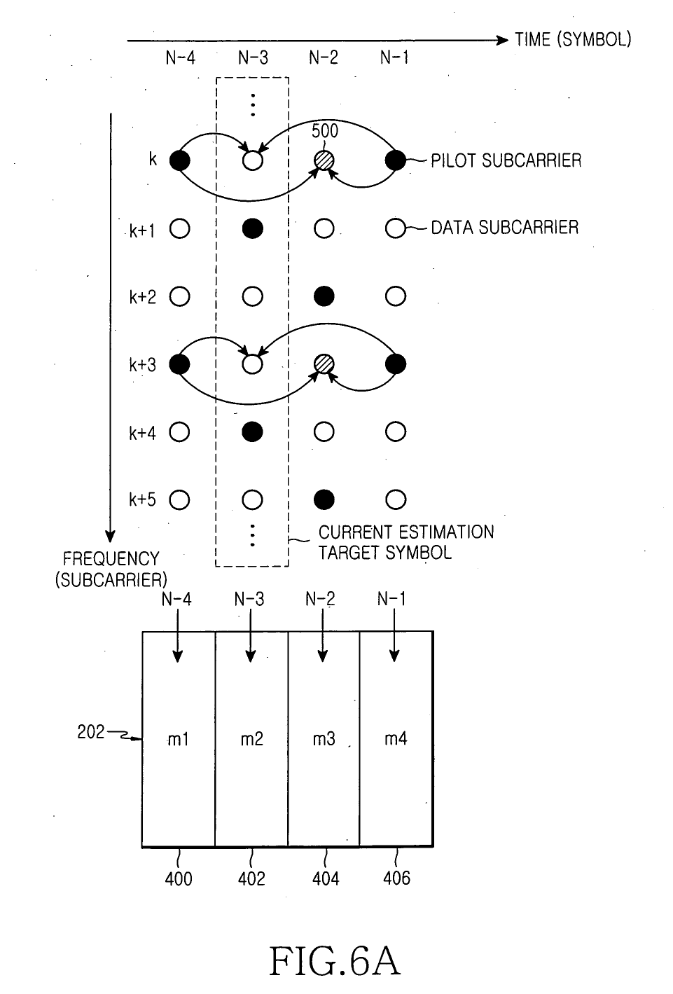

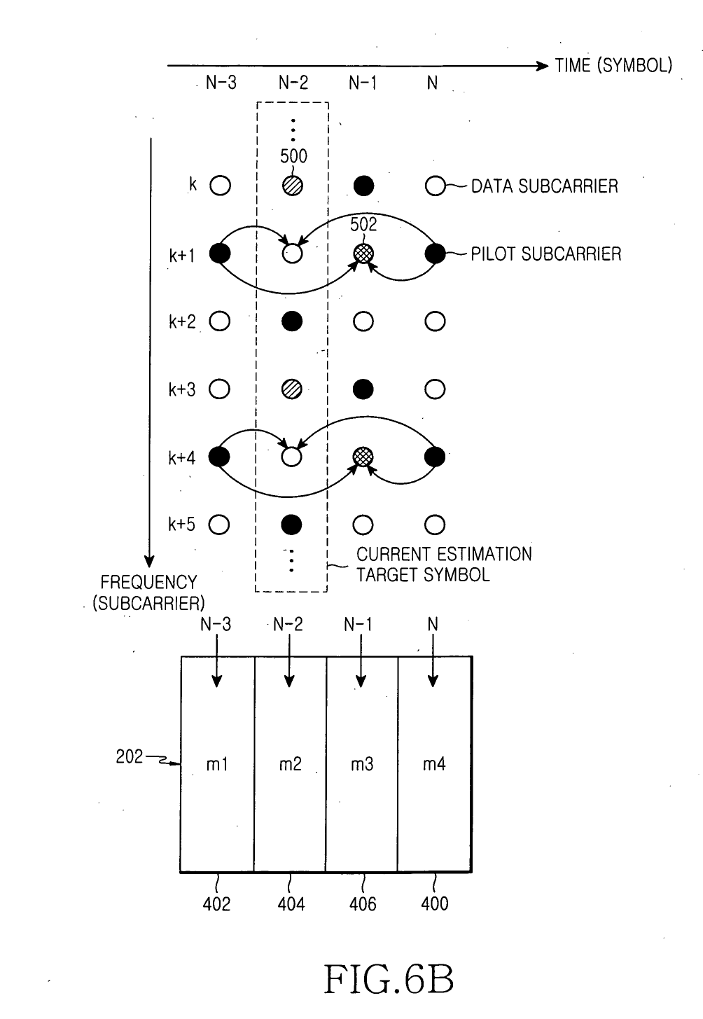

The above-mentioned time domain channel estimation is now be described with reference to FIGS. 6A and 6B to illustrate examples of linear interpolation in the time domain in accordance with an embodiment of the present invention.

Referring to FIG. 6A, when an index of a current symbol input into the channel estimator is N−1, frequency domain channel estimation associated with a symbol of Index N−3 is performed. That is, the (N−3)-th symbol is the current estimation target symbol.

The time domain channel estimation for a k-th data subcarrier among subcarriers in the (N−3)-th symbol (current estimation target symbol), is performed by linearly interpolating channel estimation values of k-th pilot subcarriers in the (N−4)-th and (N−1)-th symbols adjacent to the k-th data subcarrier in the (N−3)-th symbol on the time axis, as illustrated in Equation (1).

$${\tilde{H}}_{k} ( N - 3 ) = \frac{1}{3} \{ 2 {H}_{k} ( N - 4 ) + {H}_{k} ( N - 1 ) \} \qquad ( 1 )$$

where Hₖ(N−4) is the channel estimation value of the k-th pilot subcarrier in the (N−4)-th symbol, Hₖ(N −1) is the channel estimation value of the k-th pilot subcarrier in the (N-1)-th symbol, and \tilde{H}ₖ(N−3) is the time domain channel estimation value of the k-th data subcarrier in the (N−3)-th symbol.

Time domain channel estimation for a k-th data subcarrier 500 in the (N−2)-th symbol, which is the next estimation target symbol, is performed in advance by linearly interpolating the channel estimation values of the k-th pilot subcarriers in the (N−4)-th and (N−1)-th symbols according to Equation (2):

$${\tilde{H}}_{k} ( N - 2 ) = \frac{1}{3} \{ {H}_{k} ( N - 4 ) + 2 {H}_{k} ( N - 1 ) \} \qquad ( 2 )$$

where Hₖ(N−4) is the channel estimation value of the k-th pilot subcarrier in the (N−4)-th symbol, Hₖ(N−1) is the channel estimation value of the k-th pilot subcarrier in the (N−1)-th symbol, and \tilde{H}ₖ(N−2) is the time domain channel estimation value of the k-th data subcarrier in the (N−2)-th symbol.

The above Equations (1) and (2) illustrate linear interpolation computed by assigning weighting values according to intervals spaced between each of the k-th data subcarriers in the (N−3)-th and (N−2)-th symbols and the k-th pilot subcarriers in the (N−4)-th and (N−1)-th symbols adjacent thereto.

When linear interpolation is performed according to Equation (1), the controller 204 controls the data selector 308 to select an output of the 1-bit shifter 304 to multiply the channel estimation value Hₖ(N−4) of the k-th pilot subcarrier in the (N−4)-th by 2. After that, because the output of the 1-bit shifter 304 is added to the channel estimation value Hₖ(N−1) of the k-th pilot subcarrier in the (N−1)-th symbol, the controller 204 controls the data selector 310 to select an output of the second register 302. Next, the controller 204 controls the data selector 316 to select an output of the multiplier 314 to output the result of the linear interpolation according to Equation (1), i.e., the time domain channel estimation value \tilde{H}ₖ(N−3) of the k-th data subcarrier in the (N−3)-th symbol.

When linear interpolation is performed according to the Equation (2), the controller 204 controls the data selector 310 to select an output of the 1-bit shifter 306 to multiply the channel estimation value Hₖ(N−1) of the k-th pilot subcarrier in the (N-1)-th by 2. Then, to add the output of the 1-bit shifter 306 to the channel estimation value Hₖ(N−4) of the k-th pilot subcarrier in the (N−4)-th symbol, the controller 204 controls the data selector 308 to select an output of the first register 300. After that, the controller 204 controls the data selector 316 to select an output of the multiplier 314 to output the result of the linear interpolation according to Equation (2), i.e., the time domain channel estimation value \tilde{H}ₖ(N−2) of the k-th data subcarrier in the (N−2)-th symbol.

The time domain channel estimation value \tilde{H}ₖ(N−3) of the k-th data subcarrier in the (N−3)-th symbol, computed as described above, is output to the frequency domain interpolator as is. However, if the (N−2)-th symbol is the current estimation target symbol in the next symbol input interval after the time domain channel estimation value \tilde{H}ₖ(N−2) of the k-th data subcarrier in the (N−2)-th symbol is stored in the interpolation buffer 202, it is output to the frequency domain interpolator in the k-th subcarrier position.

The time domain channel estimation for (k+3)-th and (k+6)-th subcarriers, etc. is preferably performed the same way as that for the k-th subcarrier in the (N−3)-th symbol.

After channel estimation in the (N−3)-th symbol is performed, channel estimation in the (N−2)-th symbol is performed. The channel estimation in the (N−2)-th symbol will be described with reference to FIG. 6B. When an index of a current symbol input into the channel estimator is N, frequency domain channel estimation associated with a symbol of Index N−2 is performed. That is, the (N−2)-th symbol is the current estimation target symbol.

Because time domain channel estimation for the k-th data subcarrier 500 among subcarriers in the (N−2)-th symbol (the current estimation target symbol) has already been performed at the time of channel estimation for the (N−3)-th symbol (the previous estimation target symbol) it is omitted. Since the channel estimation value of the k-th data subcarrier in the (N−2)-th symbol is done and stored in the interpolation buffer 202, it is obtained from the interpolation buffer 202 and sent to the frequency domain interpolator.

Channel estimation for the (k+1)-th data subcarrier in the (N−2)-th symbol is performed the same way as that for the k-th data subcarrier in the (N−3)-th symbol of FIG. 6A. However, adjacent pilot subcarriers in the channel estimation for the (k+1)-th data subcarrier in the (N−2)-th symbol are (k+1)-th pilot subcarriers in the (N−3)-th and N-th symbols. In this case, the time domain channel estimation for a (k+1)-th data subcarrier 502 in the (N−1)-th symbol serving as the next estimation target symbol is performed in advance by linearly interpolating channel estimation values of the (k+1)-th pilot subcarriers in the (N−3)-th and N-th symbols, preferably in the same way as the k-th data subcarrier in the (N−2)-th symbol of FIG. 6A.

The time domain channel estimation value of the (k+1)-th data subcarrier in the (N−2)-th symbol is output to the frequency domain interpolator as is. However, after the time domain channel estimation value of the (k+1)-th data subcarrier in the (N−1)-th symbol is stored in the interpolation buffer 202, it is output to the frequency domain interpolator in a position of the (k+1)-th subcarrier when the (N−1)-th symbol is the current estimation target symbol in the next symbol input interval.

The time domain channel estimation for (k+4)-th and (k+7)-th subcarriers, etc. is preferably performed the same way as the (k+1)-th subcarrier in the (N−2)-th symbol.

Time domain channel estimation for all data subcarriers between adjacent pilot subcarriers is performed during the time interval of a current input symbol. As a result, channel estimation values of pilot subcarriers included in four consecutive symbols with a current estimation target symbol are referred to. Because the interpolation buffer 202 stores signal values of the subcarriers in four symbols, available memory is equal to the storage capacity reduced by the memory size required for one symbol as compared to a conventional buffer.

Therefore, the interpolation buffer 202 uses only storage areas 400 to 406 as first to fourth symbol memories m1 to m4, respectively, as illustrated in FIGS. 6A and 6B. The first symbol memory m1 is used for subcarriers from the previous estimation symbol; the second symbol memory m2 is used for subcarriers from the current estimation target symbol; the third symbol memory m3 is used for subcarriers from the next estimation target symbol; and, the fourth symbol memory m4 is used for subcarriers from the current input symbol.

Channel estimation in the (N−3)-th symbol is performed according to the (N−1)-th symbol input as illustrated in FIG. 6A. Subsequently, when channel estimation in the (N−2)-th symbol is performed according to the next N-th symbol input, the storage areas 400 to 406 of the interpolation buffer 202 are changed as illustrated in FIG. 6B. The storage area 400 serving as the first symbol memory m1 for subcarriers in the (N−4)-th symbol serving as the previous estimation symbol at the time of performing the channel estimation in the (N−3)-th symbol is changed to the fourth symbol memory m4 for subcarriers in the N-th symbol serving as a new input symbol. As the (N−3)-th symbol is changed to a previous estimation symbol, the storage area 402 serving as the second symbol memory m2 for subcarriers in the (N−3)-th symbol serving as the current estimation target symbol is changed to the first memory m1. As the (N−2)-th symbol is changed to a current estimation target symbol, the storage area 404 serving as the third symbol memory m3 for subcarriers in the (N−2)-th symbol serving as the next estimation target symbol is changed to the second memory m2. As the (N−1)-th symbol is changed to the next estimation target symbol, the storage area 406 serving as the fourth symbol memory m4 for subcarriers in the (N−1)-th symbol serving as the current input symbol is changed to the third memory m3.

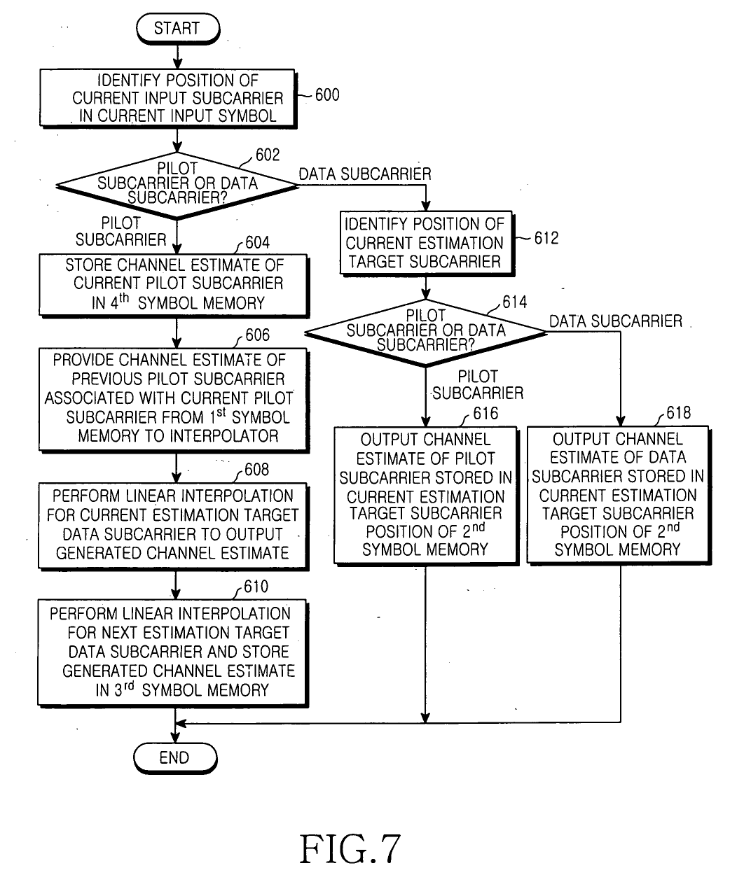

FIG. 7 is a flow chart illustrating a time domain channel estimation procedure in accordance with an embodiment of the present invention. Steps 600 to 618 illustrate a procedure for processing one subcarrier. It is assumed that the channel estimation in the next symbol illustrated in FIG. 6B is performed subsequent to the channel estimation illustrated in FIG. 6A. Time domain channel estimation in accordance with an embodiment of the present invention will be described with reference to FIG. 7. The N-th symbol is a current input symbol, the (N−1)-th symbol is the next estimation target symbol, the (N−2)-th symbol is a current estimation target symbol, and the (N−3)-th symbol is a previous estimation symbol.

First, the case where a current input subcarrier in the current input symbol of Index N is a k-th subcarrier is described. The controller 204 identifies a position of the current input subcarrier in the current input symbol of Index N in step 600. When the current input subcarrier is a pilot subcarrier in step 602, the controller 204 proceeds to step 604. However, when the current input subcarrier is a data subcarrier, the controller 204 proceeds to step 612.

Because the position of the current input subcarrier serves as a k-th subcarrier corresponding to a data subcarrier, the controller 204 proceeds to step 612. In step 612, a position of a current estimation target subcarrier in a current estimation target symbol of Index N−2 is identified. When the current estimation target subcarrier is a pilot subcarrier in step 614, the controller 204 proceeds to step 616. However, when the current estimation target subcarrier is a data subcarrier, the controller 204 proceeds to step 618.

Because the position of the current estimation target subcarrier is the k-th subcarrier corresponding to the data subcarrier 500, a channel estimation value of the data subcarrier 500 stored in the position of the k-th subcarrier serving as the current estimation target subcarrier in the second symbol memory m2 of the interpolation buffer 202 is output to the frequency domain interpolator in step 618. Here, the channel estimation value is the same as a value estimated in advance and stored in the third symbol memory m3 when the (N−3)-th symbol is the current estimation target symbol in FIG. 6A. Because the current estimation target symbol has been changed from the (N−3)-th symbol to the (N−2)-th symbol, the third symbol memory m3 is changed to the second symbol memory m2.

After channel estimation for the k-th subcarrier in the current estimation target symbol of Index N−2 is performed, a (k+1)-th subcarrier serving as the current input subcarrier in the current input symbol of Index N is input. Then, the controller 204 identifies a position of the current input subcarrier in the current input symbol of Index N in step 600. When the current input subcarrier is a pilot subcarrier in step 602, the controller 204 proceeds to step 604. However, when the current input subcarrier is a data subcarrier in step 602, the controller 204 proceeds to step 612.

Because the position of the current input subcarrier is the (k+1)-th subcarrier corresponding to a pilot subcarrier, the controller 204 proceeds to step 604. In step 604, a channel estimation value of the current input pilot subcarrier serving as the (k+1)-th subcarrier in the N-th symbol is received from the pilot channel estimator, and is stored in the position of the (k+1)-th subcarrier serving as the current input subcarrier in the fourth symbol memory m4. At the same time, the channel estimation value of the (k+1)-th pilot subcarrier in the N-th symbol is input and temporarily stored in the second register 302. The controller 204 directs the data selector 316 to select the channel estimation value of the current input subcarrier that is commonly input into the second register 302, and the data selector 316, rather than the multiplier 314 output.

Subsequently, a channel estimation value of the (k+1)-th pilot subcarrier in the (N−3)-th symbol serving as the previous pilot subcarrier associated with the current pilot subcarrier is output from the first symbol memory m1 and temporarily stored in the first register 300 in step 606.

As mentioned above, the channel estimation value of the previous pilot subcarrier is temporarily stored in the first register 300. When the channel estimation value of the current pilot subcarrier is temporarily stored in the second register 302, linear interpolation for the (k+1)-th data subcarrier in the (N−2)-th symbol (serving as a current estimation target data subcarrier) is performed according to Equation (1) in step 608. The channel estimate generated by the linear interpolation is then output to the frequency domain interpolator. The controller 204 controls the data selectors 308, 310, and 316 when linear interpolation is performed according to Equation (1).

In step 610, linear interpolation for a (k+1)-th data subcarrier 502 in the (N−1)-th symbol, serving as the next estimation target data subcarrier, is performed according to Equation (2). The generated channel estimation value is stored in the position of the (k+1)-th subcarrier, serving as the current input subcarrier, in the third symbol memory m3. The controller 204 controls the data selectors 308, 310, and 316 when the linear interpolation is performed according to Equation (2).

After channel estimation for the (k+1)-th subcarrier in the current estimation target symbol of Index N−2 is performed, a (k+2)-th subcarrier, serving as a current input subcarrier in the current input symbol of Index N, is input. Then, the controller 204 identifies a position of the current input subcarrier in the current input symbol of Index N in step 600. When the current input subcarrier is a pilot subcarrier in step 602, the controller 204 proceeds to step 604. However, when the current input subcarrier is a data subcarrier in step 602, the controller 204 proceeds to step 612.

Because the position of the current input subcarrier is the (k+2)-th subcarrier corresponding to a data subcarrier, the controller 204 proceeds to step 612 where the position of the current estimation target subcarrier is identified in the current estimation target symbol of Index N−2. When the current estimation target subcarrier is a pilot subcarrier in step 612, the controller 204 proceeds to step 616. However, when the current estimation target subcarrier is a data subcarrier in step 612, the controller 204 proceeds to step 618.

Because the position of the current estimation target subcarrier is the (k+2)-th subcarrier corresponding to a pilot subcarrier, a channel estimation value of the pilot subcarrier stored in the position of the (k+2)-th subcarrier serving as the current estimation target subcarrier in the second symbol memory m2 of the interpolation buffer 202 is output to the frequency domain interpolator in step 616. Here, the channel estimation value is the same as a value stored in the third symbol memory m3 when the (N−1)-th symbol is the current input symbol. Because the current input symbol has been changed from the (N−1)-th symbol to the N-th symbol, the third symbol memory m3 is changed to the second symbol memory m2.

Subsequently, the time domain channel estimation for the remaining (k+3)-th, (k+4)-th, and (k+5)-th subcarriers, etc. in the (N−2)-the symbol is performed preferably in the same way as that for the k-th, (k+1)-th, and (k+2) subcarriers in the (N−2)-th symbol.

The time domain channel estimation for subcarriers in order of k→k+1→k+2→k+3→k+4→k+5→ . . . in the (N−2)-th symbol is performed normally such that the frequency domain interpolator performs the frequency domain channel estimation associated with the (N−2)-th symbol. The size of the interpolation buffer 202 may be reduced by the memory required for one symbol.

When the N-th symbol is input as illustrated in FIG. 6B, the first symbol memory m1 is used to provide the interpolator 200 with the channel estimation value of a previous pilot subcarrier. After the channel estimation value of the previous pilot subcarrier from the first symbol memory m1 is stored temporarily in the first register 300 and used for time domain channel estimation for the (N−2)-th and (N−1)-th symbols, channel estimation is not affected, even though the channel estimation value of a current input pilot subcarrier is overwritten on the first symbol memory m1.

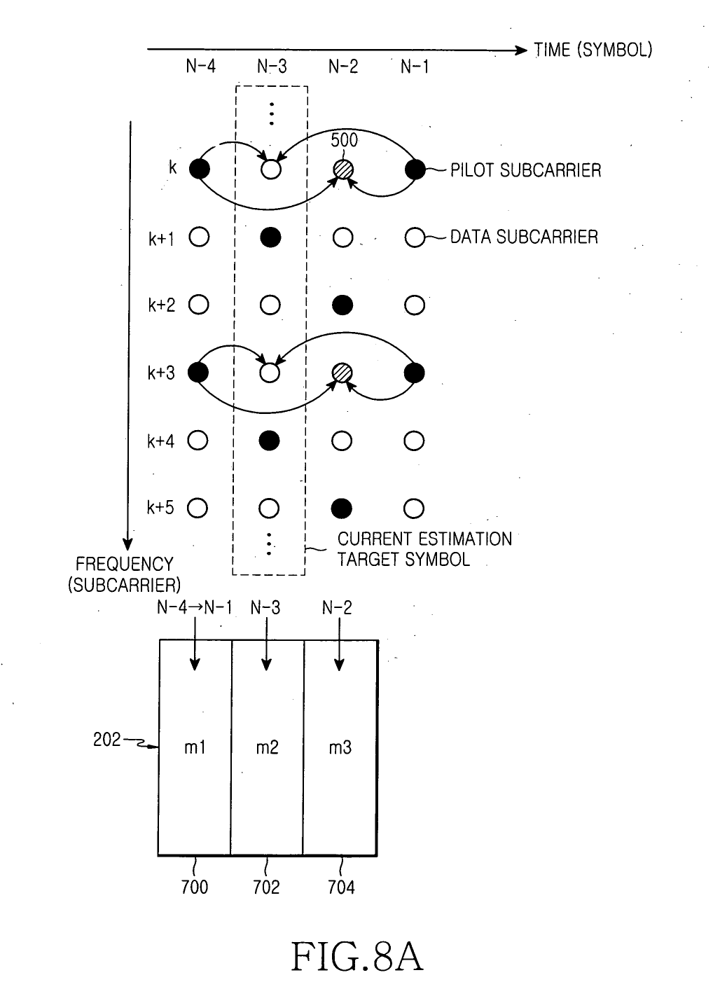

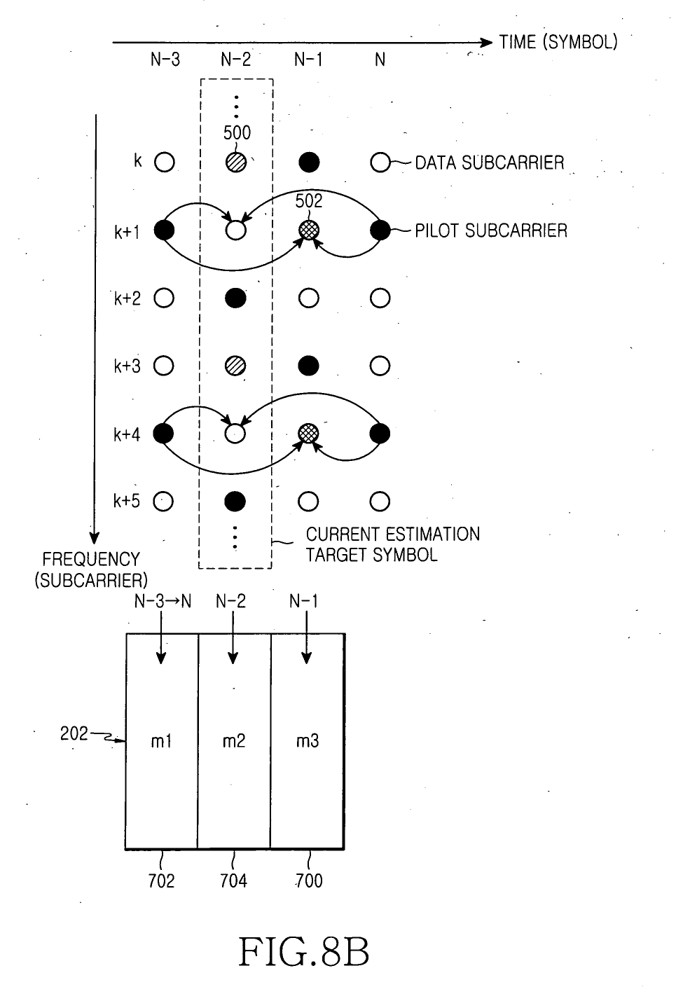

An example of using a shared storage area for both previous and current input symbols is illustrated in FIGS. 8A and 8B which correspond to FIGS. 6A and 6B, respectively.

When FIG. 8A is compared with FIG. 6A, channel estimation is the same. Second and third symbol memories m2 and m3 of storage areas 702 and 704 in FIG. 8A are the same as those in FIG. 6A. However, it can be seen from FIG. 8A that a first symbol memory m1 of a storage area 700 is different from a storage area for the (N−4)-th symbol serving as the previous estimation symbol to a storage area for the (N−1)-th symbol serving as the current input symbol.

When FIG. 8B is compared with FIG. 6B, the channel estimation is the same. Second and third symbol memories m2 and m3 of storage areas 704 and 700 in FIG. 8B are the same as those in FIG. 6B. However, it can be seen from FIG. 8B that a first symbol memory m1 of a storage area 702 is different from a storage area for the (N−3)-th symbol serving as the previous estimation symbol to a storage area for the N-th symbol serving as the current input symbol. A function of the storage area is nominally changed according to input subcarriers in the order
k→k+1→k+2→k+3→k+4→k+5→ . . . .

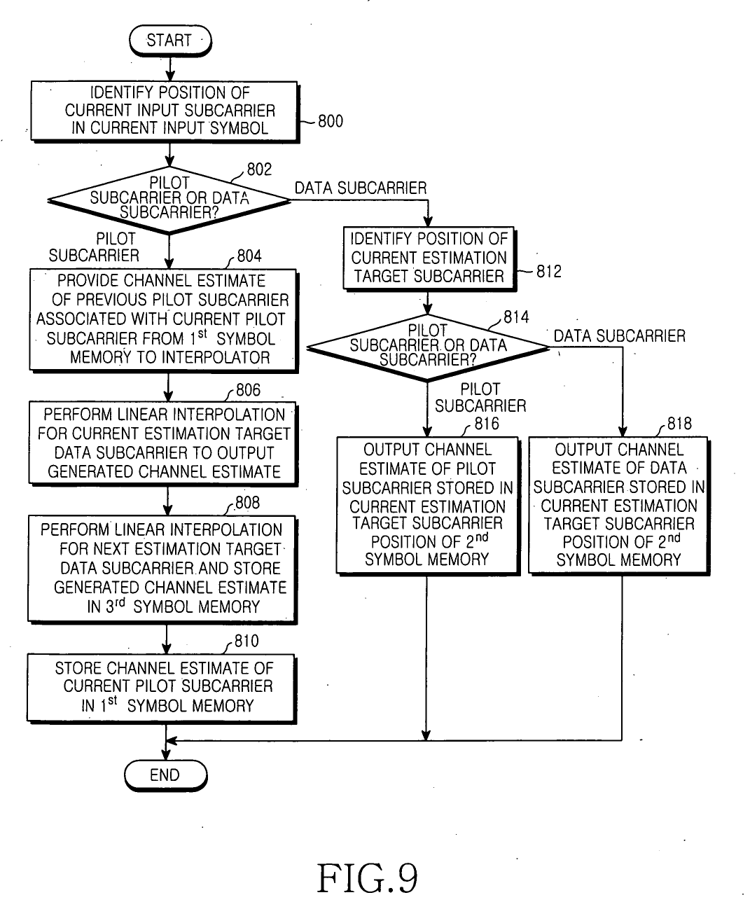

When a single storage area is used for both previous and current input symbols, the memory size of the interpolation buffer 202 used for the channel estimation associated with FIGS. 8A, 8B, and 9 may be reduced by the memory required for one symbol.

FIG. 9 is a flow chart illustrating a time domain channel estimation procedure in accordance with an alternative embodiment of the present invention when a single storage area is used for both previous and current input symbols. When steps 800 to 818 of FIG. 9 are compared with steps 600 to 618 of FIG. 7, steps 800 and 802 correspond to steps 600 and 602, steps 812 to 818 correspond to steps 612 to 618, and steps 804 to 808 correspond to steps 606 to 610. FIG.9 is different from FIG. 7 in that step 810 (corresponding to step 604) is performed after steps 804 to 808.

In FIG. 7, linear interpolation for data subcarriers in the current and next estimation target symbols is performed after the channel estimation value of the current pilot subcarrier is stored. In the example of FIG. 9, the channel estimation value of the current pilot subcarrier is stored after linear interpolation for data subcarriers in the current and next estimation target symbols is performed.

Steps 804 to 810 will be described with reference to FIG. 8B. When the current input subcarrier is the (k+1)-th pilot subcarrier, the channel estimation value of the (k+1)-th pilot subcarrier in the N-th symbol is temporarily stored in the second register 302.

In this state, the controller 204 reads the channel estimation value of the previous pilot subcarrier associated with the current pilot subcarrier (the (k+1)-th pilot subcarrier in the (N−3)-th symbol) from the first symbol memory m1 and stores it in the first register 300 temporarily.

When the channel estimation value of the current pilot subcarrier is temporarily stored in the second register 302, linear interpolation for the (k+1)-th data subcarrier in the (N−2)-th symbol, serving as a current estimation target data subcarrier, is performed according to Equation (1) in step 806. The generated channel estimation value is output to the frequency domain interpolator.

In step 808, linear interpolation for the (k+1)-th data subcarrier 502 in the (N−1)-th symbol serving as the next estimation target data subcarrier is performed according to Equation (2). The generated channel estimation value is stored in the position of the (k+1 )-th subcarrier serving as the current input subcarrier in the third symbol memory m3.

In step 810, a channel estimation value of the current input pilot subcarrier serving as the (k+1)-th subcarrier in the N-th symbol is received from the pilot channel estimator, and is stored in the position of the (k+1)-th subcarrier serving as the current input subcarrier in the first symbol memory m1.

When a single storage area is used for both previous and current input symbols, the memory size of the interpolation buffer 202 may be reduced by the memory required for two symbols, as compared with the conventional memory size, without degrading channel estimation performance.

Time domain channel estimation for all data subcarriers between adjacent pilot subcarriers is performed during the time interval of a current input symbol. Channel estimation for the next estimation target symbol is performed, and the channel estimation value is stored. Then, when the next estimation target symbol becomes the current estimation target symbol, the stored channel estimation value is output, such that the memory required for the channel estimation is reduced without degrading channel estimation performance.

Although preferred embodiments of the present invention have been disclosed for illustrative purposes, those skilled in the art will appreciate that various modifications, additions and substitutions are possible, without departing from the scope of the present invention.

An example with two data subcarriers between adjacent pilot subcarriers on the time axis has been herein. Of course, the case there are more than two data subcarriers between adjacent pilot subcarriers can be applied to the present invention. In this case, the number of symbol memories is increased by the added number of next estimation target symbols for which linear interpolation is performed during the time interval of one symbol.

The present invention can apply not only to a communication system using an orthogonal frequency division multiplexing (OFDM) scheme(OFDM system), but also to a communication system using an orthogonal frequency division multiple access (OFDMA) scheme (OFDMA system), or any system in which channel estimation is performed using the adjacent pilot subcarriers.

Therefore, the present invention is not limited to the above-described embodiments, but is defined by the following claims, along with their full scope of equivalents.

What is claimed is:

1. A method for performing channel estimation for a plurality of data subcarriers in a system in which pilots are assigned every predetermined number of symbols with respect to defined subcarriers, a position of a pilot subcarrier between the subcarriers is shifted in a unit of a predetermined number of symbols, and the data subcarriers are positioned between adjacent pilot subcarriers on a time axis, the method comprising:
inputting channel estimation values of pilot subcarriers in a current input symbol; and
performing time domain channel estimation for data subcarriers positioned between adjacent pilot subcarriers by linearly interpolating channel estimation values of adjacent pilot subcarriers associated with each of the pilot subcarriers in the current input symbol during a time interval of the current input symbol.

2. The method according to claim 1, wherein the step of performing the time domain channel estimation comprises:
identifying a current input position associated with subcarriers in the current input symbol;
when the current input position is a pilot subcarrier position, storing a channel estimation value of a current pilot subcarrier currently input;
linearly interpolating the channel estimation value of the current pilot subcarrier and a channel estimation value of a previous pilot subcarrier previously input and stored adjacent to the current pilot subcarrier on the time axis, and generating channel estimation values of data subcarriers positioned between the current and previous pilot subcarriers;
outputting a channel estimation value of a data subcarrier in a current estimation target symbol among the channel estimation values of the data subcarriers;
storing a channel estimation value of a data subcarrier in a next estimation target symbol among the channel estimation values of the data subcarriers;
when the current input position is not a pilot subcarrier position, identifying a position of a current estimation target subcarrier;
when the position of the current estimation target subcarrier is a pilot subcarrier position, outputting a channel estimation value of a pilot subcarrier previously input and stored in the current estimation target subcarrier position; and
when the position of the current estimation target subcarrier is a data subcarrier position, outputting a channel estimation value of a data subcarrier estimated during a time interval of the previous estimation symbol and storing the channel estimate in a corresponding position.

3. The method according to claim 1, further comprising:
identifying a current input position associated with subcarriers in the current input symbol;
when the current input position is a pilot subcarrier position, linearly interpolating a channel estimation value of a current pilot subcarrier currently input and a channel estimation value of a previous pilot subcarrier previously input and stored adjacent to the current pilot subcarrier on the time axis, and generating channel estimation values of data subcarriers positioned between the current and previous pilot subcarriers;
outputting a channel estimation value of a data subcarrier in a current estimation target symbol among the channel estimation values of the data subcarriers;
storing a channel estimation value of a data subcarrier in a next estimation target symbol among the channel estimation values of the data subcarriers;
when the current input position is not a pilot subcarrier position, identifying a position of a current estimation target subcarrier;
when the position of the current estimation target subcarrier is a pilot subcarrier position, outputting a channel estimation value of a pilot subcarrier previously input and stored in the current estimation target subcarrier position;
when the position of the current estimation target subcarrier is a data subcarrier position, outputting a channel estimation value of a data subcarrier estimated during a time interval of the previous estimation symbol and stored in a corresponding position; and
storing the channel estimation value of the current pilot subcarrier.

4. The method according to claim 2, wherein the number of data subcarriers positioned between the current and previous pilot subcarriers is two.

5. The method according to claim 3, wherein the number of data subcarriers positioned between the current and previous pilot subcarriers is two.

6. A method for performing channel estimation for a plurality of data subcarriers in a system in which pilots are assigned every predetermined number of symbols with respect to defined subcarriers, a position of a pilot subcarrier between the subcarriers is shifted in a unit of a predetermined number of symbols, and the data subcarriers are positioned between adjacent pilot subcarriers on a time axis, the method comprising:
inputting channel estimation values of pilot subcarriers in a current input symbol;
linearly interpolating channel estimation values of adjacent pilot subcarriers associated with each of the pilot subcarriers in the current input symbol during a time interval of the current input symbol to perform time domain channel estimation for data subcarriers positioned between the adjacent pilot subcarriers; and
outputting a channel estimation value of a data subcarrier in a current estimation target symbol among channel estimation values of the data subcarriers, and outputting a channel estimation value of a data subcarrier in a next estimation target symbol when the next estimation target symbol is changed to the current estimation target symbol after the channel estimation value of the data subcarrier in the next estimation target symbol is stored.

7. The method according to claim 6, wherein the number of data subcarriers positioned between the adjacent pilot subcarriers is two.

8. An apparatus for performing channel estimation for a plurality of data subcarriers in a system in which pilots are assigned every predetermined number of symbols with respect to defined subcarriers, a position of a pilot subcarrier between the subcarriers is shifted in a unit of a predetermined number of symbols, and the data subcarriers are positioned between adjacent pilot subcarriers on a time axis, the apparatus comprising:
an interpolator for linearly interpolating a channel estimation value of a current pilot subcarrier currently input among pilot subcarriers in a current input symbol and a channel estimation value of a previous pilot subcarrier associated therewith, and generating channel estimation values of data subcarriers in a current estimation target symbol and at least one next estimation target symbol positioned between the current and previous pilot subcarriers;
an interpolation buffer for storing channel estimation values of pilot subcarriers in the current input symbol, channel estimation values of pilot subcarriers in a previous input symbol, channel estimation values of pilot subcarriers in the current estimation target symbol, and channel estimation values of data subcarriers in the at least one next estimation target symbol; and
a controller for controlling linear interpolation in the interpolator and storing output operations in the interpolation buffer such that time domain channel estimation for data subcarriers between the current and previous pilot subcarriers associated with each of the pilot subcarriers in the current input symbol is performed during a time interval of the current input symbol.

9. The apparatus according to claim 8, wherein the controller outputs a channel estimation value of a data subcarrier in the current estimation target symbol among channel estimation values of the data subcarriers, and outputs a channel estimation value of a data subcarrier in the at least one next estimation target symbol when the next estimation target symbol is changed to the current estimation target symbol after the channel estimation value of the data subcarrier in the at least one next estimation target symbol is stored.

10. The apparatus according to claim 9, wherein the interpolation buffer separately includes a storage area for storing the channel estimation values of the pilot subcarriers in the current input symbol, and a storage area for storing channel estimation values of pilot subcarriers in a previous estimation symbol.

11. The apparatus according to claim 10, wherein the number of data subcarriers positioned between the adjacent pilot subcarriers is two, and wherein the interpolation buffer includes four symbol areas.

12. The apparatus according to claim 9, wherein the interpolation buffer uses a common storage area for storing channel estimates of pilot subcarriers in both current and previous input symbols.

13. The apparatus according to claim 12, wherein the number of data subcarriers positioned between the adjacent pilot subcarriers is two, and wherein the interpolation buffer includes three symbol areas.

14. A method for performing time domain channel estimation in a communication system, the method comprising:
inputting channel estimation values of current pilot subcarriers as pilot subcarriers in a current input symbol; and
performing time domain channel estimation for data subcarriers positioned between the current pilot subcarrier and an adjacent pilot subcarrier, which is a pilot subcarrier adjacent to the current pilot subcarrier in time domain, by linearly interpolating channel estimation values of the current pilot subcarrier and the adjacent pilot subcarrier associated with each of the current pilot subcarriers in the current input symbol during a time interval of the current input symbol.

15. The method according to claim 14, wherein the step of performing the time domain channel estimation comprises:
linearly interpolating the channel estimation values of the current pilot subcarrier and the adjacent pilot subcarrier, and generating channel estimation values of data subcarriers associated with each of the current pilot subcarriers;
outputting a channel estimation value of a current data subcarrier as a data subcarrier in a current time domain channel estimation target symbol among the data subcarriers;
storing a channel estimation value of a data subcarrier in a next time domain channel estimation target symbol among the data subcarriers; and
storing the channel estimation value of the current pilot subcarrier.

16. The method according to claim 15, wherein the channel estimation value of the current pilot subcarrier is stored by overwriting the channel estimation value of the adjacent pilot subcarrier.

17. The method according to claim 14, wherein the step of performing the time domain channel estimation comprises:
storing the channel estimation value of the current pilot subcarrier associated with each of the current pilot subcarriers;
linearly interpolating the channel estimation values of the current pilot subcarrier and the adjacent pilot subcarrier, and generating channel estimation values of data subcarriers; outputting a channel estimation value of a current data subcarrier as a data subcarrier in a current time domain channel estimation target symbol among the data subcarriers; and
storing a channel estimation value of a data subcarrier in a next time domain channel estimation target symbol among the data subcarriers.

18. An apparatus for performing time domain channel estimation in a communication system, the apparatus comprising:
an interpolator for performing time domain channel estimation for data subcarriers positioned between a current pilot subcarrier, which is a pilot subcarrier in a current input symbol, and an adjacent pilot subcarrier, which is a pilot subcarrier adjacent to the current pilot subcarrier in time domain, by linearly interpolating channel estimation values of the current pilot subcarrier and the adjacent pilot subcarrier associated with each of the current pilot subcarriers in the current input symbol during a time interval of the current input symbol in accordance with a predetermined control;
an interpolation buffer for storing channel estimation values of the current pilot subcarriers, channel estimation values of the adjacent pilot subcarriers, channel estimation values of data subcarriers in a next time domain channel estimation target symbol;
a controller for controlling an operation of the interpolator to performed time domain channel estimation for the data subcarriers associated with each of the current pilot subcarriers during the time interval of the current input symbol.

19. The apparatus according to claim 18, wherein the interpolator linearly interpolates the channel estimation values of the current pilot subcarrier and the adjacent pilot subcarrier, and generates channel estimation values of data subcarriers associated with each of the current pilot subcarriers;
outputs a channel estimation value of a current data subcarrier as a data subcarrier in a current time domain channel estimation target symbol among the data subcarriers;
stores a channel estimation value of a data subcarrier in a next time domain channel estimation target symbol among the data subcarriers; and
stores the channel estimation value of the current pilot subcarrier.

20. The apparatus according to claim 19, wherein the interpolator stores the channel estimation value of the current pilot subcarrier in the interpolation buffer by overwriting the channel estimation value of the current pilot subcarrier on the channel estimation value of the adjacent pilot subcarrier.

21. The apparatus according to claim 18, wherein the interpolator stores the channel estimation value of the current pilot subcarrier associated with each of the current pilot subcarriers;
linearly interpolates the channel estimation values of the current pilot subcarrier and the adjacent pilot subcarrier, and generates channel estimation values of data subcarriers;
outputs a channel estimation value of a current data subcarrier as a data subcarrier in a current time domain channel estimation target symbol among the data subcarriers; and
stores a channel estimation value of a data subcarrier in a next time domain channel estimation target symbol among the data subcarriers.

22. The apparatus according to claim 21, wherein the interpolator stores the channel estimation value of the current pilot subcarrier in the interpolation buffer, separately from the channel estimation value of the adjacent pilot subcarrier.
